(19) United States
(12) Patent Application Publication
(10) Pub. No.: US 2004/0108681 A1
(43) Pub. Date: Jun. 10, 2004

(54) Bottom bracket assembly

(76) Inventor: Cheng-Hsun Chiang, Taichung City (TW)

Correspondence Address: CHARLES A BAXLEY, Hart, Baxley, Daniels & Holton, 90 John Street, Third Floor, New York, NY, 10038, US

(21) Appl. No.: 10/313,607

(22) Filed: Dec. 6, 2002

(51) Int. Cl. B62K 19/34

(52) U.S. Cl. 280/281.1

(57) ABSTRACT

A bottom bracket assembly includes a hollow bottom bracket having two protrusions extending an inside of the hollow bottom bracket and an axle rotatably extends through the bottom bracket and includes two ridges such that two retaining rings are mounted to the axle and stopped by the two protrusions. Each retaining member has a stop flange extending from an inside thereof. Steel balls are retained in a space between the retaining rings, the flanges, the axle and the ridges.

### FIELD OF THE INVENTION

The present invention relates to a bottom bracket assembly for bicycles and includes two protrusions extending from an inside of the bottom bracket. Two outer retaining rings are mounted to the axle and contact the protrusions so as to retain steel balls between the retaining rings, the protrusions and the axle.

### BACKGROUND OF THE INVENTION

A conventional bicycle bottom bracket assembly generally includes a hollow bottom bracket and an solid axle is rotatably extended through the hollow bottom bracket by two bearings mounted on the solid axle. Nevertheless, the conventional bottom bracket assembly is too heavy such that it cannot be satisfied by the riders who need a light bicycle so as to perform speedy and/or stunt performances. Furthermore, the space between the inside of the hollow bottom bracket and the axle is limited because the inner retaining ring and the outer retaining ring of the bearings so that the steel balls retained between the inner retaining ring and the outer retaining ring cannot be large steel balls.

The present invention intends to provide a bottom bracket assembly for bicycles wherein the space between the bottom bracket and the axle is larger than the conventional assembly so that larger steels balls can be used in the bearings.

### SUMMARY OF THE INVENTION

In accordance with one aspect of the present invention, there is provided a bottom bracket assembly which comprises a hollow bottom bracket having two protrusions extending an inside of the hollow bottom bracket and an axle rotatably extends through the bottom bracket and includes two ridges extending outward from an outer periphery of the axle.

Two retaining rings each have a stop flange extending from an inside thereof and the retaining rings are mounted to the axle and stopped by the two protrusions. Steel balls are retained in a space between the retaining rings, the flanges, the axle and the ridges.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view, partly removed, to show the bottom bracket assembly of the present invention;

FIG. 2 is an exploded view to show the bottom bracket assembly of the present invention, and

FIGS. 3A to 3D show steps of assembling the bottom bracket assembly of the present invention.

### DETAILED DESCRIPTION OF THE PREFERRED EMBODIMENT

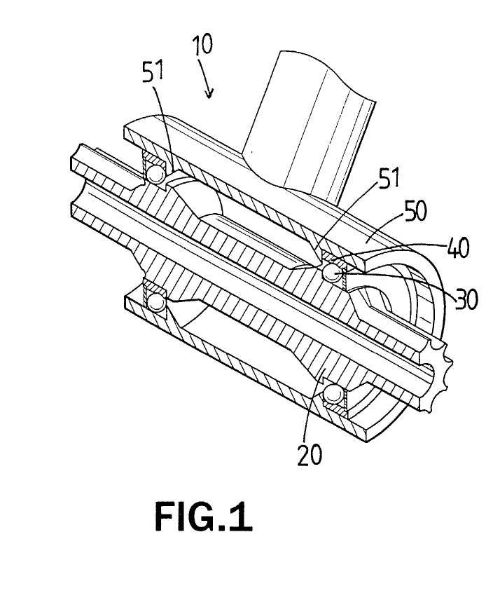

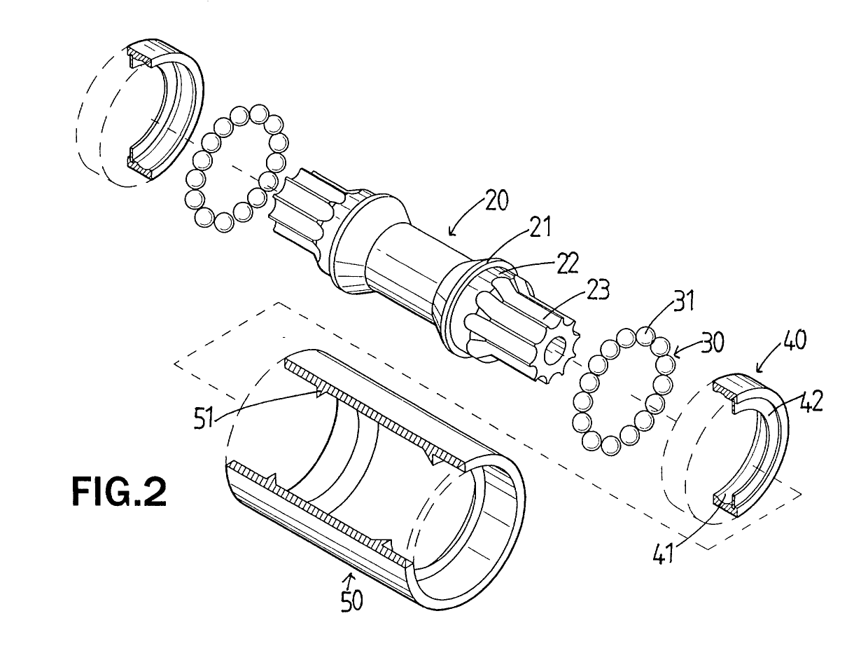

Referring to FIGS. 1 and 2, the bottom bracket assembly 10 of the present invention comprises a hollow bottom bracket 50 having two protrusions 51 extending an inside of the hollow bottom bracket 50 and each protrusion 51 includes a flat side.

An axle 20 rotatably extends through the bottom bracket 50 and includes two ridges 21 extending outward from an outer periphery of the axle 20 such that the an area 22 is defined for receiving steel balls 31 of the bearing. Two retaining rings 40 each have a stop flange 42 extending from an inside thereof and a groove 41 for retaining the steel balls 31 therein.

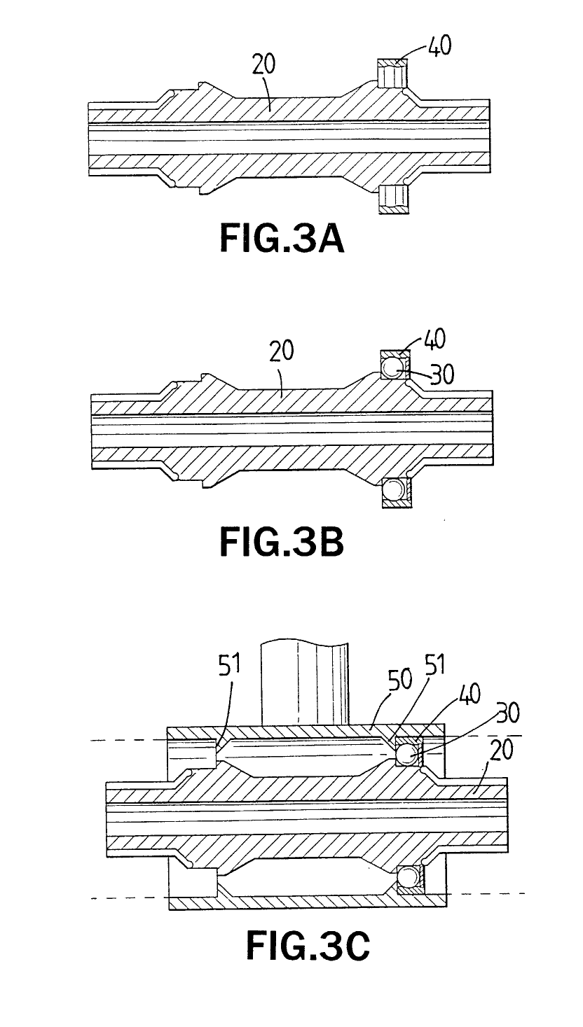

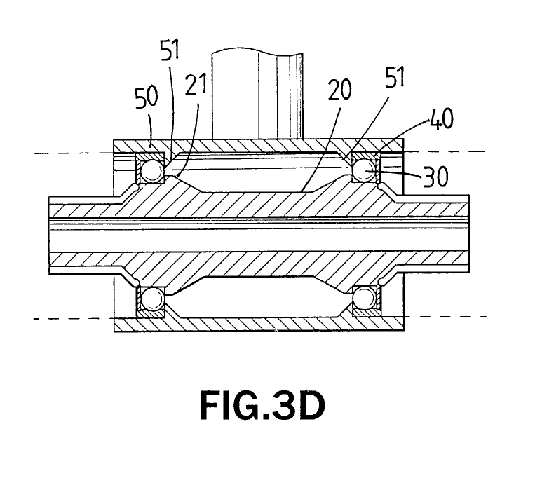

When assembling the bottom bracket assembly 10, one of the two retaining rings 40 are first mounted to the axle 20 as shown in FIG. 3A at an angle and stopped by the two protrusions 51. The steel balls 31 are retained in a space between the retaining rings 40, the flanges 42, the axle 20 and the ridges 21 as shown in FIG. 3B. The axle 20 is then inserted in the bottom bracket 50 as shown in FIG. 3C and the other retaining ring 40 is mounted to the axle 20 from the other end of the axle 20. As shown in FIG. 3D, the steel balls 31 are retained as the way described in FIG. 3B. It is noted that a plurality of grooves 23 are defined longitudinally in the outer periphery of two ends of the axle 20 so that the steel balls 31 are able to be put to the space via the grooves 23.

The available space between the hollow bottom bracket 50 and the axle 20 is larger than the conventional bottom bracket assembly so that larger steel balls 31 can be used. Besides, the assembly needs only one retaining ring for each set of bearing and the total weight of the assembly can be reduced.

While we have shown and described the embodiment in accordance with the present invention, it should be clear to those skilled in the art that further embodiments may be made without departing from the scope of the present invention.

What is claimed is:

1. A bottom bracket assembly comprising:
a hollow bottom bracket having two protrusions extending an inside of the hollow bottom bracket;
an axle rotatably extending through the bottom bracket and including two ridges extending outward from an outer periphery of the axle, and two retaining rings each having a stop flange extending from an inside thereof and the retaining rings mounted to the axle and stopped by the two protrusions, steel balls retained in a space between the retaining rings, the flanges, the axle and the ridges.

2. The assembly as claimed in claim 1 further comprising a plurality of grooves defined longitudinally in the outer periphery of two ends of the axle, the steel balls being moved to the space via the grooves.
